(19) United States
(12) Patent Application Publication
(10) Pub. No.: US 2026/0145012 A1
(43) Pub. Date: May 28, 2026

(54) METHOD OF MOVING ELECTRIC VEHICLES

(71) Applicant: Mobile Road Service Solutions, LLC, Redwood City, CA (US)

(72) Inventors: Brian Banks, Redwood City, CA (US); Steve Lewis, I, Rio Rancho, NM (US); Zachary Lewis, Rio Rancho, NM (US)

(21) Appl. No.: 19/456,404

(22) Filed: Jan. 22, 2026

Related U.S. Application Data
(63) Continuation of application No. 18/499,929, filed on Nov. 1, 2023.
(60) Provisional application No. 63/381,848, filed on Nov. 1, 2022.

(51) Int. Cl. A62C 27/00; A62C 3/07; A62C 99/00; B60P 3/07; B60P 3/12; B65D 88/54

(52) U.S. Cl. CPC A62C 27/00; A62C 3/07; A62C 99/0072; B60P 3/07; B60P 3/122; B65D 88/542

(57) ABSTRACT

Example embodiments relate to containment units usable for safely containing, storing and transporting items such as electric vehicles.

### CROSS-REFERENCE TO RELATED APPLICATIONS

This application is a divisional of U.S. patent application Ser. No. 18/499,929 which was filed with the United States Patent and Trademark Office on Nov. 1, 2023 which in turn claims the benefit of US Provisional Ser. No. 63/381,848 which was filed with the United States Patent Trademark Office on Nov. 1, 2022, the entire contents of each of which are herein incorporated by reference.

### BACKGROUND

### 1. Field

Example embodiments relate to containment units usable for safely containing, transporting and storing items such as electric vehicles.

### 2. Description of the Related Art

Electric vehicles are vehicles that use one or more electric motors for propulsion. Modern electric vehicles are powered by batteries which, unfortunately, are prone to igniting fires. It is known such fires are extremely dangerous and difficult to extinguish and prone to spontaneous re-ignition. The inventors, therefore, have sought to develop a container that can safely transport and/or store an electric vehicle and facilitate extinguishment of any initial or secondary fires that may be generated by the transported or stored electric vehicle.

### SUMMARY

Without intending to limit the invention, the inventors have designed containment units which may at least partially enclose an electric vehicle. The containment units generally have three walls and a pivot wall which may, in one or more embodiments, act as a ramp to allow an electric vehicle to be placed into the containment units. Other embodiments utilize a ramp to assist in loading an electric vehicle into the containment unit. The pivot wall may pivot upwards and/or sideways to create a generally waterproof containment space in which the electric vehicle may reside. The containment units include ports and valves which may connect to one or more fire hoses which may be used to provide and control water to the containment units to submerge all or a portion of the electric vehicle in the event the electric vehicle catches fire or to prevent fire. The containment units may also have drainage systems allowing any water in the containment units to be discharged, collected, and properly disposed of.

### BRIEF DESCRIPTION OF THE DRAWINGS

Example embodiments are described in detail below with reference to the attached drawing figures, wherein:

FIG. 1 is a first perspective view of a containment unit in accordance with example embodiments;

FIG. 2 is a second perspective view of the containment unit in accordance with example embodiments;

FIG. 3 is a first side view of the containment unit in accordance with example embodiments;

FIG. 4 is a top view of the containment unit in accordance with example embodiments;

FIG. 5 is a view of a front wall of the containment unit in accordance with example embodiments;

FIG. 6 is a back view of the containment unit in accordance with example embodiments;

FIG. 7 is another view of the front of the containment unit in accordance with example embodiments;

FIG. 8 is another side view of the containment unit in accordance with example embodiments;

FIG. 9 is another back view of the containment unit in accordance with example embodiments;

FIG. 10 is another perspective view of the containment unit in accordance with example embodiments;

FIG. 11 is another side view of the containment unit in accordance with example embodiments;

FIG. 12 is another side view of the containment unit in accordance with example embodiments;

FIG. 13 is another perspective view of the containment unit in accordance with example embodiments;

FIG. 14 is another perspective view of the containment unit in accordance with example embodiments;

FIG. 15 is another perspective view of the containment unit in accordance with example embodiments;

FIG. 16 is a perspective view of a containment unit in accordance with example embodiments;

FIG. 17 is another perspective view of a containment unit in accordance with example embodiments;

FIG. 18 is a side view of a containment unit in accordance with example embodiments;

FIG. 19 is a back view of a containment unit in accordance with example embodiments;

FIG. 20 is a side view of a containment unit in accordance with example embodiments;

FIG. 21 is a back view of a containment unit in accordance with example embodiments;

FIG. 22 is a perspective view of a containment unit in accordance with example embodiments;

FIG. 23 is a perspective view of a containment unit in accordance with example embodiments;

FIG. 24 is a perspective view of a containment unit in accordance with example embodiments;

FIG. 25 is a perspective view of a containment unit in accordance with example embodiments;

FIG. 26 is a top view of a containment unit in accordance with example embodiments;

FIG. 27 is a side view of a containment unit with an antitheft frame in accordance with example embodiments;

FIG. 28 is a perspective view of a containment unit with an antitheft frame in accordance with example embodiments;

FIG. 29 is a perspective view of a containment unit with an antitheft frame in accordance with example embodiments;

FIG. 30 is a perspective view of a containment unit with an antitheft frame in accordance with example embodiments;

FIG. 31 is a perspective view of a containment unit with an antitheft frame in accordance with example embodiments;

FIG. 32 is a side view of a containment unit with an antitheft frame in accordance with example embodiments;

FIG. 33 is a top view of a containment unit in accordance with example embodiments;

FIG. 34 is a side view of a containment unit in accordance with example embodiments;

FIG. 35 is a front view of a containment unit in accordance with example embodiments;

FIG. 36 is a back view of a containment unit in accordance with example embodiments;

FIG. 37 is a view of a floor of a containment unit in accordance with example embodiments;

FIG. 38 is a side view of a floor of a containment unit in accordance with example embodiments;

FIG. 39 is a view of a side wall of a containment unit in accordance with example embodiments;

FIG. 40 is a view of a side wall of a containment unit in accordance with example embodiments;

FIG. 41 is a view of a front wall of a containment unit in accordance with example embodiments;

FIG. 42 is a top view of a front wall of a containment unit in accordance with example embodiments;

FIG. 43 is a top view of a pivoting wall of a containment unit in accordance with example embodiments;

FIG. 44 is a back view of a pivoting wall of a containment unit in accordance with example embodiments;

FIG. 45 is a partial view of a pivoting wall with a seal in accordance with example embodiments;

FIG. 46 is a partial side view of a pivoting wall with a seal in accordance with example embodiments;

FIG. 47 is a locking mechanism in accordance with example embodiments;

FIG. 48 are view of components of the latching mechanism in accordance with example embodiments;

FIGS. 49-54 show loading of an item into a containment unit in accordance with example embodiments;

FIG. 55 is a view of an inside of a containment unit in accordance with example embodiments;

FIG. 56 is a view of an inside of a containment unit in accordance with example embodiments;

FIG. 57 is a view of an inside of a containment unit in accordance with example embodiments;

FIG. 58 in a view of a clamp in accordance with example embodiments; and

FIG. 59 is a view of a back of a containment unit.

### DETAILED DESCRIPTION

Example embodiments will now be described more fully with reference to the accompanying drawings. Example embodiments are not intended to limit the disclosure since the disclosure may be embodied in different forms. Rather, example embodiments are provided so that this disclosure will be thorough and complete, and will fully convey the scope of the disclosure to those skilled in the art. In the drawings, the sizes of components may be exaggerated for clarity.

In this application, when a first element is described as being “on” or “connected to” a second element, the first element may be directly on or directly connected to the second element or may be on or connected to an intervening element that may be present between the first element and the second element. When a first element is described as being “directly on” or “directly connected to” a second element, there are no intervening elements. In this application, the term “and/or” includes any and all combinations of one or more of the associated listed items.

In this application, spatially relative terms merely describe one element's relationship to another. The spatially relative terms are intended to encompass different orientations of the structure. For example, if a first element of a structure is described as being “above” a second element, the term “above” is not meant to limit the disclosure since, if the structure is turned over, the first element would be “beneath” the second element. As such, use of the term “above” is intended to encompass the terms “above” and “below”. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Example embodiments relate to containment units usable for containing and/or transporting items such as electric vehicles.

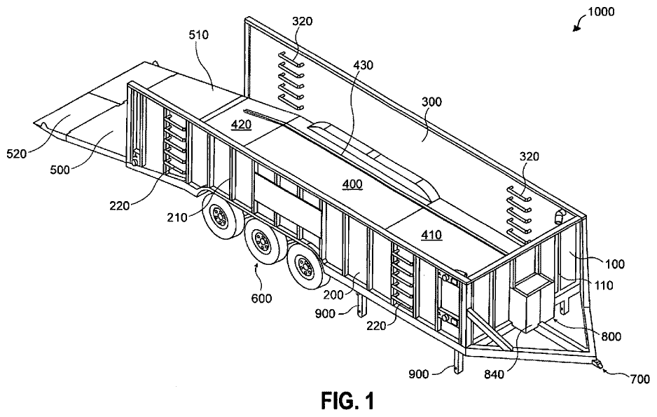

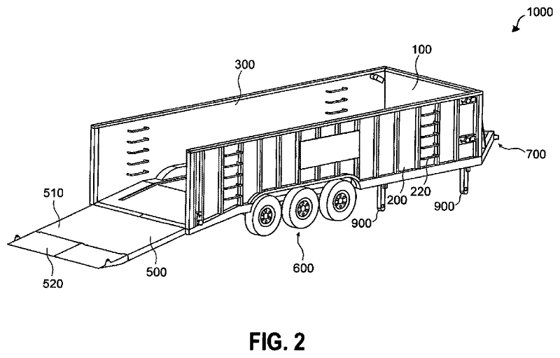

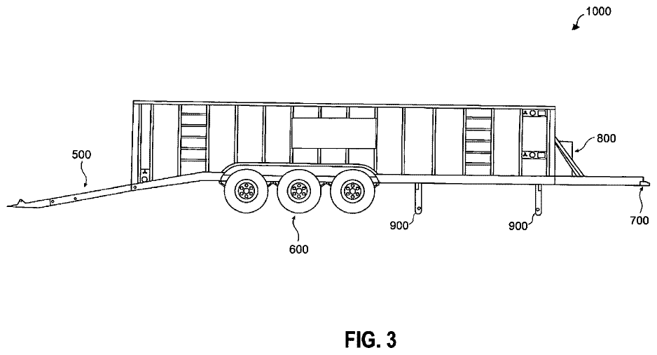

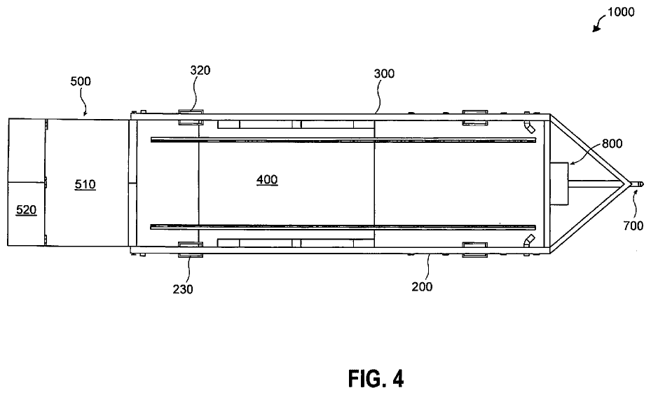

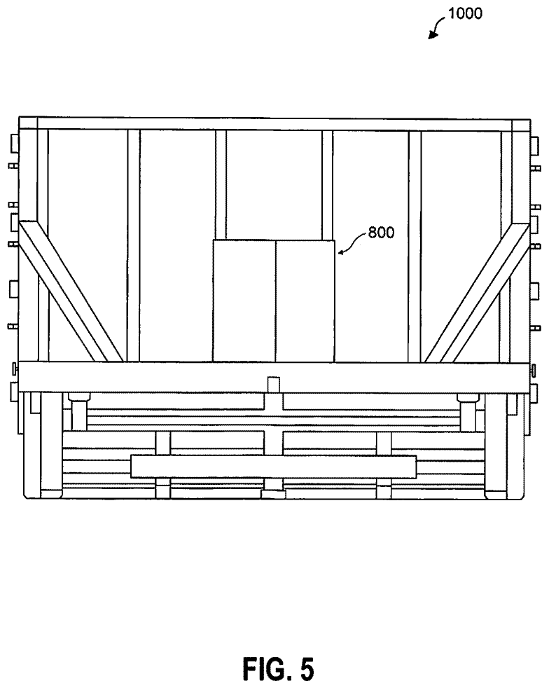

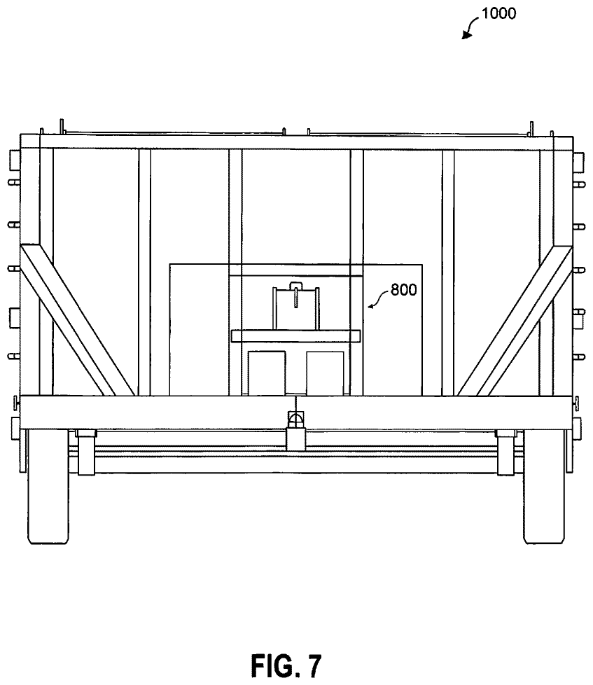

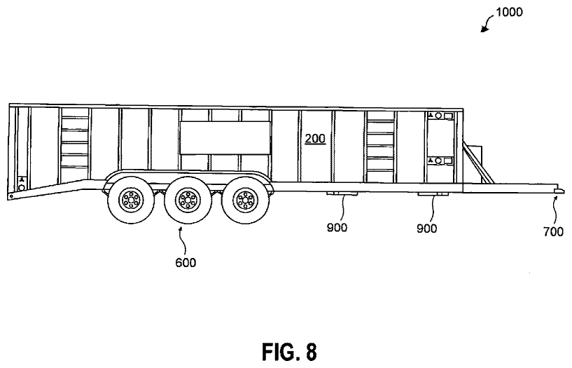

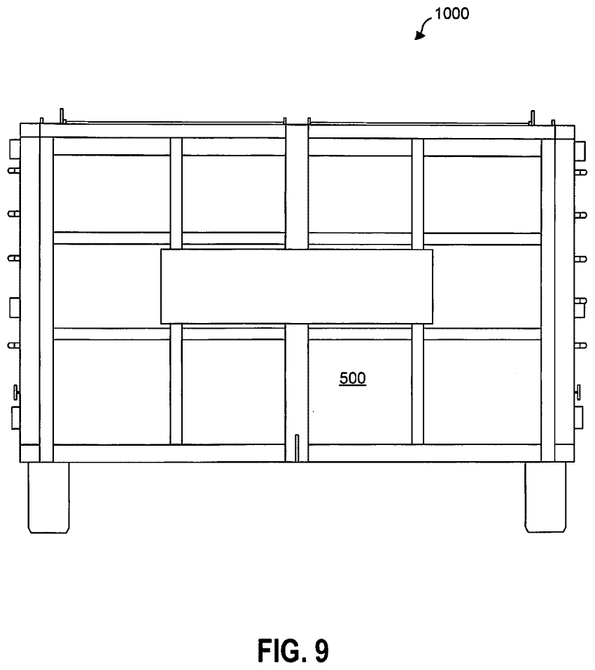

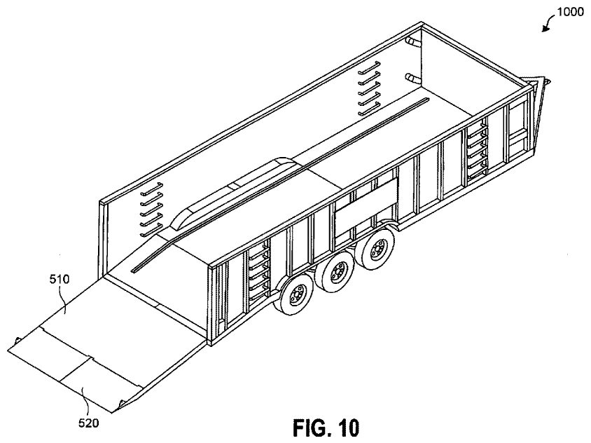

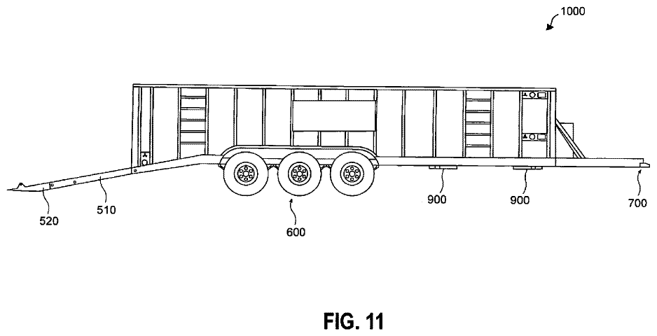

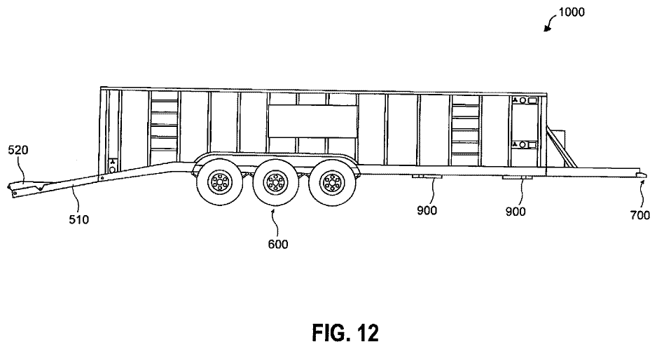

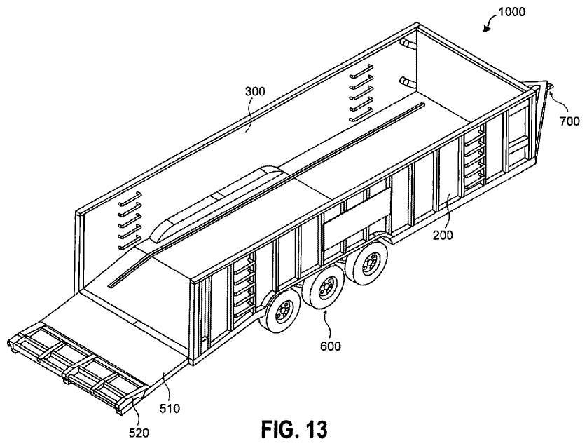

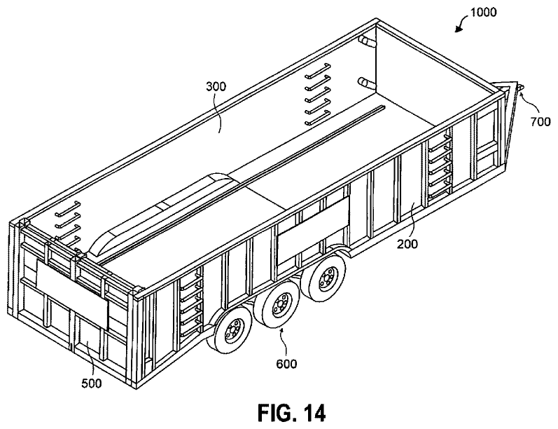

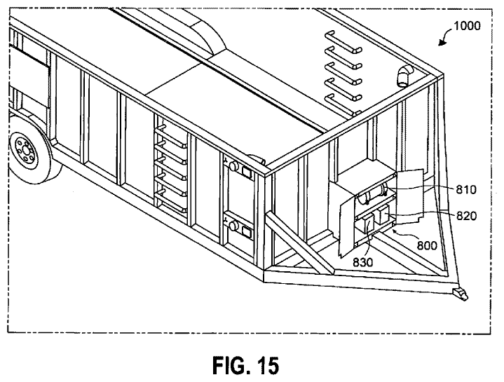

FIGS. 1-15 are views of a containment unit 1000 in accordance with a nonlimiting example of the invention. As shown in FIGS. 1-15, the containment unit 1000 may be generally box shaped and sized to accommodate an item, such as, but not limited to, an electric vehicle. In the nonlimiting example of FIGS. 1-15 the containment unit 1000 has a front wall 100, a first side wall 200, a second side wall 300, a floor 400, and a pivoting wall 500 (which may function as a ramp). The front wall 100, first side wall 200, second side wall 300, floor 400, and pivoting wall 500 may be thought of as forming a box. The pivoting wall 500 may be pivoted downwards, as shown in at least FIG. 1, to allow the item, for example, an electric vehicle, to enter the containment unit 1000. The pivoting wall 500 may be pivoted upwards, as shown in at least FIG. 8, to contain the item and prevent the item from exiting the containment unit 1000. In the nonlimiting example embodiment of FIGS. 1-15, the containment unit 1000 is configured as a mobile unit. As such, the containment unit 1000 may additionally include wheels 600 to impart mobility to the containment unit 1000. The containment unit 1000 may further include a coupler 700 which may couple the containment unit 1000 to a vehicle, such as, but not limited to, a car or a truck. The coupler 700, in one nonlimiting embodiment, may receive a trailer ball from a towing vehicle, however it is understood the invention is not limited thereto.

In example embodiments the containment unit 1000 of FIGS. 1-15 may be used to transport an item susceptible to fire. For example, it is well known electric vehicles are prone to fire of such intensity that it is difficult to extinguish. Such vehicles may be pushed into the containment unit 1000 using the pivoting wall 500 as a ramp so the item can gain entrance into a space formed by front wall 100, first side wall 200, second side wall 300 and the pivoting wall 500 (when the pivoting wall 500 is pivoted upwards). This area, in this application, shall be referred to as the containment area. While pushing an item into the containment unit 1000 is certainly possible, the example embodiment of FIGS. 1-15 is not limited thereto as the containment unit 1000 may include an actuator 800 arranged on or near the front wall 100 which may facilitate bringing the item into the containment area so the item need not be pushed into the containment area. The actuator 800, in one embodiment, is a winch with a cable 810 that may attach to the item and pull the item into the containment area. The actuator 800 may be powered by one or more power sources 820 and 830 which, in one embodiment, may be batteries. Although two power sources are shown in the figures, it is clear the actuator 800 may be powered by a single power source or more than two power sources.

In the nonlimiting example of FIGS. 1-15 the front wall 100 is illustrated as a substantially vertical wall with one or more panels and vertical members 110. The front wall 100 itself may be made from steel and/or aluminum (or a combination of the two) and may be treated with a fire-resistant coating. For example, the side of the front wall 100 facing the containment area may be treated with a reinforced hydrophobic cementitious hybrid or some other fire-resistant material. The vertical members 110 may be made from any suitable members such as, but not limited to, square or rectangular metallic and/or nonmetallic tubing, angled metal (for example, angle iron), metallic and/or nonmetallic I-beams, metallic and/or nonmetallic H-Beams, or metallic and/or nonmetallic W-Beams. A box 840 may be attached to the front wall 100. The box 840 may support, enclose, and/or protect the actuator 800 and power sources 820 and 830. In one nonlimiting embodiment, the box 840 may include doors so a user can access the actuator 800 and power sources 820 and 830. In the event the actuator 800 includes the winch and cable 810 the front wall 100 may include a hole 102 through which the cable 810 may pass and enter the containment area. The hole 102, in one nonlimiting example embodiment, may have a seal applied thereto to allow the cable 810 to pass through the front wall 100 while making the hole substantially water proof. In another embodiment the hole 102 is arranged above an anticipated water level in the containment unit 1000 thus obviating the need for a seal. In yet another embodiment the cable 810 is routed over the top of the front wall 100. In the nonlimiting example of FIGS. 1-15 a pulley system may be used to route the cable from the winch and to an item to be pulled. The pulley system may be configured to route the cable 810 through the hole 102 in the front wall 100 or over the top of the front wall 100.

In the nonlimiting example of FIGS. 1-15 the first and second side walls 200 and 300 are illustrated as a substantially vertical walls with vertical members 210. The first and second side walls 200 and 300 themselves may be made from steel and/or aluminum (or a combination of the two) and may be treated with a fire-resistant coating. The reinforcing members 210 may be made from any suitable members such as, but not limited to, square or rectangular metallic and/or nonmetallic tubing, angled metal (for example, angle iron), metallic and/or nonmetallic I-beams, metallic and/or nonmetallic H-beams, or metallic and/or nonmetallic W-beams. As shown in the figures, the first and second side walls 200 and 300 may each include one or more ladders 220 and 320 to allow a user to climb into and out of the containment area. The ladders 220 and 320 may be arranged on the outsides of the first and second side walls 200 and 300, on the insides of the first and second side walls 200 and 300, or on both the outsides and insides of the first and second side walls 200 and 300. In the example of FIGS. 1-15 eight ladders are provided. This allows speed of access to enter the containment area, monitor the containment area by standing on exterior ladders, and provides firefighters and/or technicians four places to access from the top if needed. Having four places to access the containment area minimizes travel for technicians or firefighters and therefore minimizes periods of exposure time. Without the ladders a firefighter or technician may have to enter the containment area on the front end or back end and may have to walk past or near a burning vehicle. Having the ladders arranged in FIGS. 1-15 minimizes this risk.

In the nonlimiting example of FIGS. 1-15 floor 400 may be a substantially horizontal floor upon which the item may be placed. The floor 400 itself may be made from steel and/or aluminum (or a combination of the two) and may be treated with a fire-resistant coating. The floor 400 may, in some embodiments have not only a horizontal portion 410, but an inclined portion 420 as well. The inclined portion may help transition the item into the containment area. For example, different EV vehicles have different lengths and the inclined portion 420 may be configured to allow EV vehicles of many popular lengths to transition into the containment area. The floor 400 may also include guides 430 which may help control the item as it is being drawn or pushed into the containment area. The guides 430 may resemble angle iron or channel iron fixed to the floor 400.

In the nonlimiting example of FIGS. 1-15 the pivoting wall 500 may be configured to pivot from the back of the containment unit 1000 to the front of the containment unit 1000. The pivoting wall 500 itself may be made from steel and/or aluminum (or a combination of the two) and may be treated with a fire-resistant coating. When in a downward pivoted position (for example, in FIG. 1) an item, for example, an electric vehicle, can enter the containment area by being pushed into the containment unit 1000 or drawn into the containment unit 1000 by using the actuator 800. When in an upward position (for example, in FIG. 8), the pivoting wall 500 may be substantially vertical. When in the upwards portion the pivoting wall 500 seals off the containment area and creates a substantially watertight containment area. In the nonlimiting example of FIGS. 1-15 the pivoting wall 500 is shown having a first section 510 and a second section 520. The first section 510 may be pivotally connected with respect to the floor 400 and/or side walls 200 and 300. For example, in one embodiment the pivoting wall 500 is pivotally connected to the floor 400. In another embodiment the pivoting wall 500 is pivotally connected to the first and second side walls 200 and 300. The second section 520 may be arranged at an outer end of the first section 510 and may be pivotally connected to the first section 510. Having a pivoting wall 500 of a first section 510 and a second section 520 allows for some flexibility in controlling the pivoting wall 500, however, the pivoting wall, in other embodiments, may be comprised of only a single section, or more than two sections. That said, in the example of FIGS. 1-15, the pivoting wall 500 is designed factoring an “angle of approach” and “breakover angle” into the design. “Approach” is the clearance required between ground and vehicle from front bumper to front wheels (for example scraping parking curb in a parking lot with underside of front of car). “Breakover” is the distance to ground mid vehicle (for example speed bumps scraping middle of vehicle when passing over). This unit 1000 will allow vehicles with an approach and breakover angle larger than 11.5 degrees (which accommodates many conventional electric vehicles including Tesla Model 3 and Porsche Taycan).

In the nonlimiting example of FIGS. 1-15 the containment unit 1000 may be towed by a vehicle from one location to another. For example, the containment unit 1000 may be towed near an electric vehicle which may or may not be smoldering. In operation the pivoting wall 500 may be pivoted to its downward pivoted position (as shown in FIG. 1) and a cable from the actuator 800 may be pulled through the containment area and to the electric vehicle and may be attached to the electric vehicle via a conventional means such as, but not limited to, a hook or a clamp. The actuator 800 (for example a winch) may then be actuated to pull the electric vehicle across the pivoting wall 500 and into the containment area. After the electric vehicle is in the containment area the pivoting wall 500 may be pivoted to its upward position (as shown in FIG. 8).

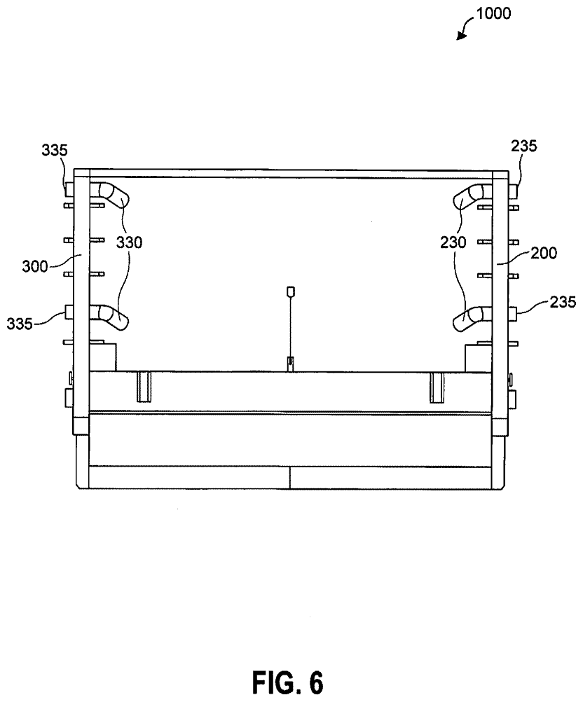

As previously explained, electric vehicles may be difficult to extinguish once they catch fire or re-ignite. The nearby physical environment, such as the ground or nearby structures or vehicles, is protected from a smoldering or burning electric vehicle by virtue of being in the containment area. However, in the nonlimiting example of FIGS. 1-15 containment unit 1000 includes additional features which may facilitate extinguishing any fire present in the containment unit 1000. For example, as shown in the various figures, the side walls 200 and 300 include ports 230 and 330 (see at least FIG. 6) through which water or other fire suppression material may enter the containment unit 1000. The ports 230 and 330 resemble pipes which, in some embodiments, maybe be arranged to have an angle of entry of about 30 degrees from the horizontal and/or vertical. It has been shown having an angle of entry of about 30 degrees expedites a cooling process as the water contacts an item in the containment area. Further, even if the water does not directly contact the item from the ports 230 and 330, angling the entry of water into the containment area creates a swirling effect in the containment area which facilitates cooling. In the nonlimiting example of FIGS. 1-15 the ports 230 and 330 are angled so as to be directed towards the front wall 100, though the invention is not limited thereto. For example, the ports 230 and 330 may be angled so as to be directed towards the pivoting wall 500 which may also promote water recirculation. While in some embodiments having the angle of entry of water be about 30 degrees the invention is not limited thereto. In fact, in some embodiments the ports 230 and 330 may actually terminate and be substantially flush with the insides of the walls 200 and 300. This allows larger items (for example, larger electric vehicles) to enter the containment area.

In one nonlimiting example embodiment of FIGS. 1-15 the ends 235 and 335 of the ports 230 and 330 may be configured to connect to conventional fire hoses. Therefore, a conventional firetruck having water storage capacity may easily connect their water supply to the containment unit 1000 to deliver water to the containment area via the ends 235 and 335 to introduce water into the containment area to submerge a smoldering item, such as a smoldering electric vehicle. Associated with the ports 230 and 330 are valves which may be shut off to the ports 230 and 330 to prevent water from exiting the containment area via the ports 230 and 330. The valves allow safe firefighter operation as it allows for disconnecting or changing the water supply line without excess pressure and without losing any contaminated water. In the example embodiment of FIGS. 1-15 four ports are shown, however, the invention is not limited thereto as another version of the containment unit 1000 may have more than four ports or less than four ports.

As explained above, the containment unit 1000 may contain an item, for example, an electric vehicle, where the containment area is filled with water to a level required to extinguish a fire. To remove the water from the containment unit 1000 the floor 400 may be fitted with multiple water drains. For example, the floor 400 may have one or more water drains. In one example, the floor 400 includes one center floor drain arranged at the base of the pivoting wall 500 and may be used as a “last drain used” to capture residual contaminated water not evacuated with primary evacuation valves (below). In one nonlimiting example embodiment, less than five (5) gallons may remain to be removed via this drain. Another drain may be comprised of a primary evacuation valve and standard fire department connection in the very rear of each side down at floor level. In one embodiment, the containment unit 1000 includes one on each side, but the invention may, in actuality, have more than two evacuation valves. Hazmat services that may be needed to evacuate the water and properly treat/dispose the water typically use fire department standard hose and connections, so the containment unit 1000 is compatible for them. In the example embodiment of FIGS. 1-15, having ports 230 and 330 allowing entry of water via a hose and drains allowing for draining of the containment unit 1000 allows for active pumping via one or more hoses as well gravity drain via a hose to drain most of, if not all of, the contaminated water. This can be used for enhanced water circulation to expedite cooling by pulling hot/contaminated water out of the containment area and into an exterior containment vessel or tank of a hazmat truck while still pumping water in on the other end of the chamber, even during active fire. Locating evacuation valves at the rear of the containment area and intake valves at opposite end promotes flow and circulation.

In the example of FIGS. 1-15 the containment unit 1000 may be moved from one location to another under the influence of a vehicle, such as, but not limited to, a car or a truck. The containment unit 1000 may be disconnected from the vehicle so as to be a stand alone unit. In order to promote stability and support and distribute the weight of water that may be present in the containment unit 1000, the containment unit 1000 of FIGS. 1-15 includes gravity drop support legs 900. The gravity support legs 900 may be pivotally supported allowing the support legs 900 to pivot downwards, as shown in at least FIG. 1, to provide stability to the containment unit 1000 or to pivot upwards, as shown in at least FIG. 8 when the containment unit 1000 is moved from one location to another. In one embodiment the support legs 900 are configured as telescoping support legs allowing the length of the support legs 900 to be adjusted to accommodate uneven terrains.

Though not shown in the figures, the nonlimiting example of FIGS. 1-15 may include additional features. For example, the containment unit 1000 of FIGS. 1-15 may additionally include heavy duty slots attached to or embedded in the bottom of the floor 400 for forklift rails. This would allow a forklift to interface with and move the containment unit 1000. The slots may be configured to allow a forklift to interface with the containment unit 1000 from either side and allows for ease, speed, and safety when moving the containment unit 1000 around within a storage yard or facility. This also allows the containment unit 1000 to potentially be stacked with another containment unit 1000 which may reduce a storage footprint.

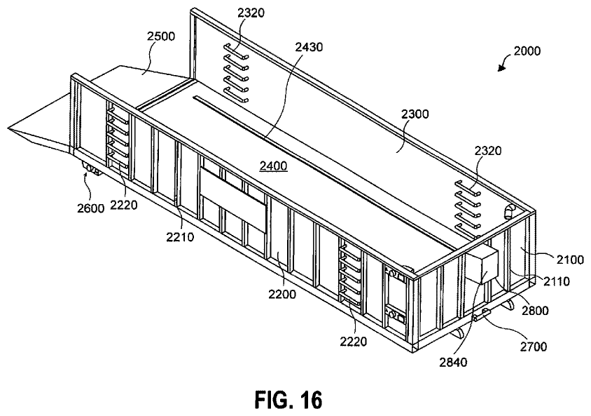

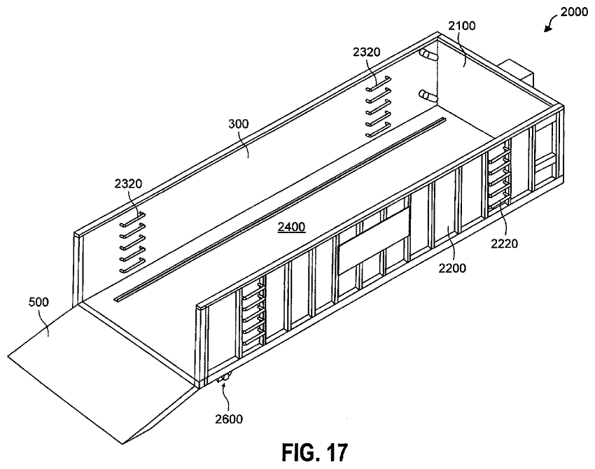

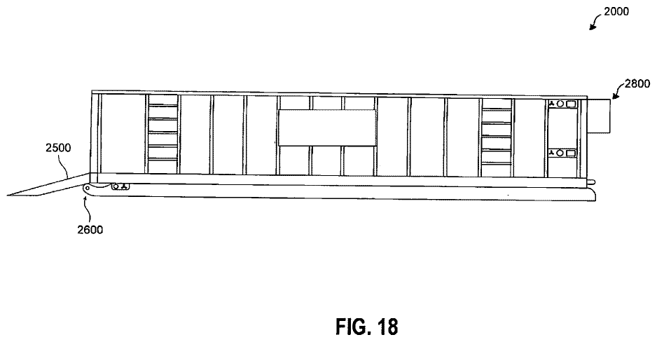

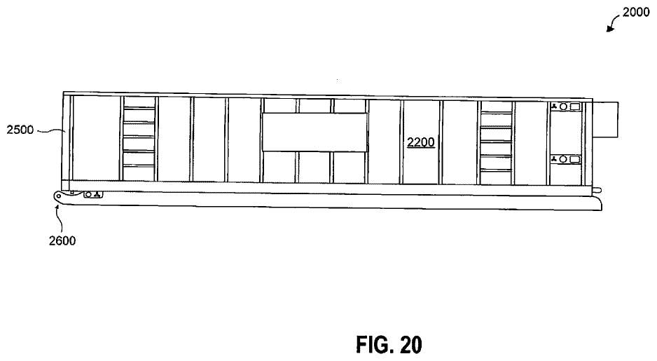

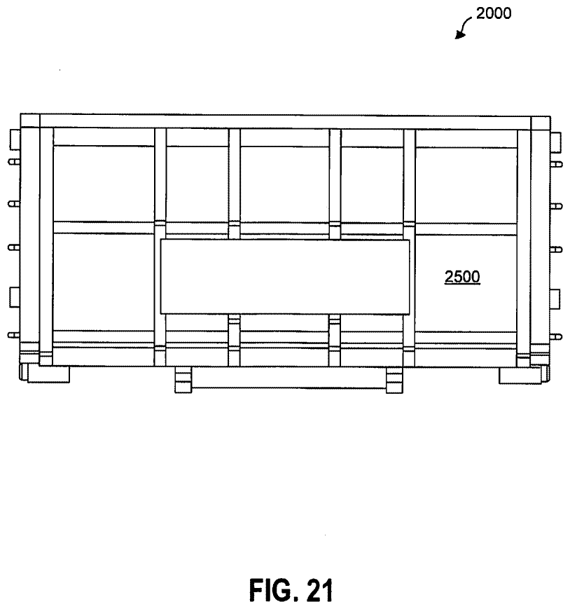

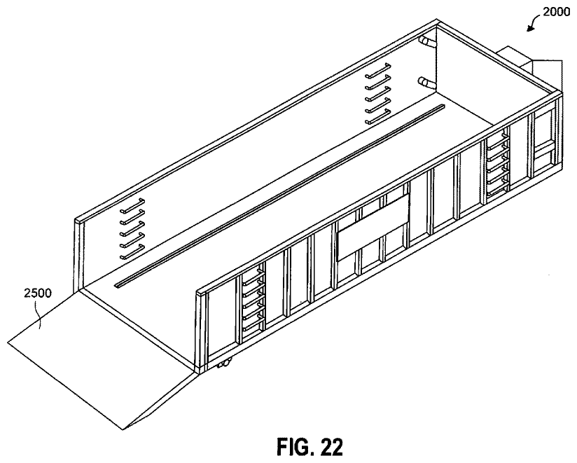

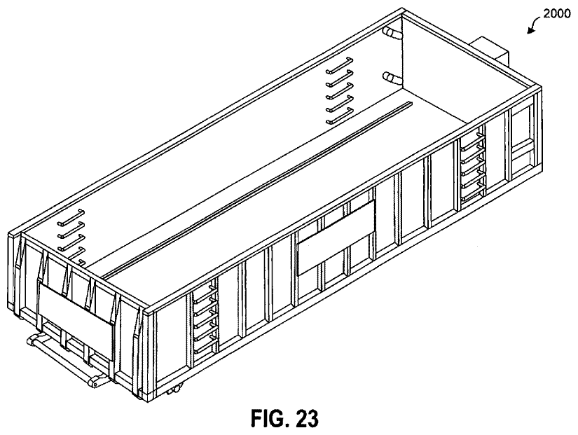

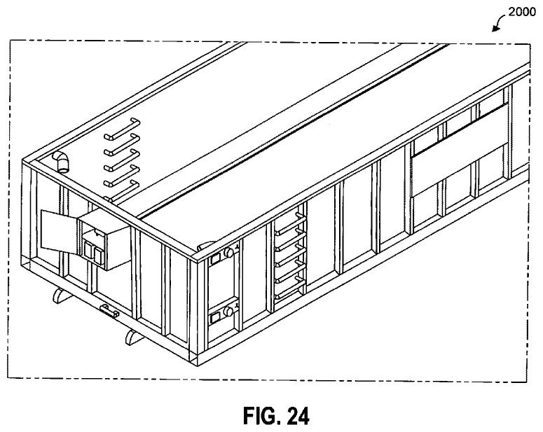

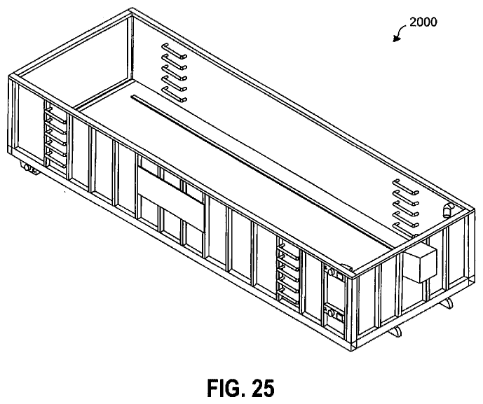

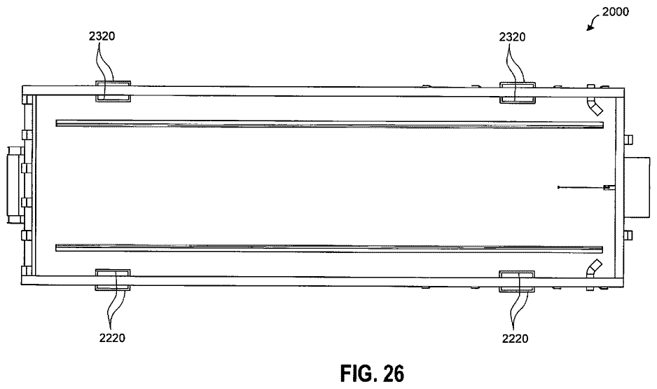

FIGS. 16-26 illustrate another nonlimiting example of a containment unit 2000 in accordance with an example embodiment of the invention. Like the embodiment of FIGS. 1-15, the containment unit 2000 of FIGS. 16-26 may be generally box shaped and sized to accommodate an item, such as, but not limited to, an electric vehicle. In the nonlimiting example of FIGS. 16-26 the containment unit 2000 has a front wall 2100, a first side wall 2200, a second side wall 2300, a floor 2400, and a pivoting wall 2500 (which may function as a ramp). The front wall 2100, first side wall 2200, second side wall 2300, floor 2400, and pivoting wall 2500 may be considered a box. The pivoting wall 2500 may be pivoted downwards, as shown in at least FIG. 16, to allow the item, for example, an electric vehicle, to enter the containment unit 2000. The pivoting wall 2500 may be pivoted upwards, as shown in at least FIG. 20, to contain the item and prevent the item from exiting the containment unit 2000. In the nonlimiting example embodiment of FIGS. 16-26, the containment unit 2000 is configured as a roll-on/roll off container. As such, the containment unit 2000 may additionally include rollers 2600 to allow the containment unit 2000 to be rolled on or off a deck of a truck. To that end, the containment unit 2000 may further include a coupler 2700 which may allow an arm or other device to couple thereto and draw the containment unit 2000 onto the deck. The coupler 2700, in one nonlimiting embodiment, may resemble a bar to which a hook and/or clamp may attach.

In example embodiments the containment unit 2000 of FIGS. 16-26 may be used to transport an item susceptible to fire. As explained previously, it is well known electric vehicles are prone to fire of such intensity that it is difficult to extinguish. Such vehicles may be driven, pushed or pulled into the containment unit 2000 using the pivoting wall 2500 as a ramp so the item can gain entrance into the space formed by front wall 2100, first side wall 2200, second side wall 2300 and the pivoting wall 2500 (when the pivoting wall 2500 is pivoted upwards). This area, in this application, shall be referred to as the containment area. Like the embodiment of FIGS. 1-15, the containment unit 2000 includes an actuator 2800 arranged on or near the front wall 2100 which may facilitate bringing the item into the containment area so the item need not be pushed into the containment area. The actuator 2800, in one embodiment, is a winch with a cable 2810 that may attach to the item and pull the item into the containment area. The actuator 2800 may be powered by one or more power sources 2820 and 2830 which, in one embodiment, may be batteries. Although two power sources are shown in the figures, it is clear the actuator 2800 may be powered by a single power source or more than two power sources.

In the nonlimiting example of FIGS. 16-26 the front wall 2100 is illustrated as a substantially vertical wall with vertical members 2110. The front wall 2100 itself may be made from steel and/or aluminum (or a combination of the two) and may be treated with a fire-resistant coating. The reinforcing members 2110 may be made from any suitable members such as, but not limited to, square or rectangular metallic and/or nonmetallic tubing, angled metal (for example, angle iron), metallic and/or nonmetallic I-beams, metallic and/or nonmetallic H-Beams, or metallic and/or nonmetallic W-Beams. A box 2840 may be attached to the front wall 2100. The box 2840 may support, enclose, and/or protect the actuator 2800 and power sources 2820 and 2830. In one nonlimiting embodiment, the box 2840 may include doors so a user can access the actuator 2800 and power sources 2820 and 2830. In the event the actuator 2800 includes the winch and cable 2810 the front wall 2100 may include a hole through which the cable may pass and enter the containment area. The hole, in one nonlimiting example embodiment, may have a seal applied thereto to allow the cable to pass through the front wall 2100 while making the hole substantially water proof. In another embodiment the hole is arranged above an anticipated water level in the containment unit 21000 thus obviating the need for a seal. In yet another embodiment the cable is routed over the top of the front wall 2100. In the nonlimiting example of FIGS. 16-26 a pulley system may be used to route the cable from the winch and to an item to be pulled. The pulley system may be configured to route the cable to the hole in the front wall 2100 or over the top of the front wall 2100.

In the nonlimiting example of FIGS. 16-26 the first and second side walls 2200 and 2300 are illustrated as a substantially vertical walls with vertical reinforcing members 2210 and 2310. The first and second side walls 2200 and 2300 themselves may be made from steel and/or aluminum (or a combination of the two) and may be treated with a fire-resistant coating. The reinforcing members 2210 and 2310 may be made from any suitable members such as, but not limited to, square or rectangular metallic and/or nonmetallic tubing, angled metal (for example, angle iron), metallic and/or nonmetallic I-beams, metallic and/or nonmetallic H-beams, or metallic and/or nonmetallic W-beams. As shown in the figures, the first and second side walls 2200 and 2300 may each include a one or more ladders 2220 and 2320 to allow a user to climb into and out of the containment area. The ladders 2220 and 2320 may be arranged on the outsides of the first and second side walls 2200 and 2300, on the insides of the first and second side walls 2200 and 2300, or on both the outsides and insides of the first and second side walls 2200 and 2300. Like the example of FIGS. 1-15 eight ladders may be provided. This allows speed of access to enter the containment area, monitor the containment area by standing on exterior ladders, and provides firefighters four places to access from the top if needed. Having four places to access the containment area minimizes travel for technicians or firefighters and therefore minimizes periods of exposure time. Without the ladders a firefighter or technician may have to enter the containment area on the front end or back end and may have to walk past or near a burning vehicle. Having the ladders arranged in FIGS. 16-26 minimizes this risk.

In the nonlimiting example of FIGS. 16-26 floor 2400 may be a substantially horizontal floor upon which the item may be placed. The floor 2400 itself may be made from steel and/or aluminum (or a combination of the two) and may be treated with a fire-resistant coating. The horizontal floor 2400 may, in some embodiments, be substantially vertical, but in other embodiments is inclined. The floor 2400 may also include guides 2430 which may help control the item as it is being drawn or pushed into the containment area. The guides 2430 may resemble angle iron or channel iron fixed to the floor 400.

In the nonlimiting example of FIGS. 16-26 the pivoting wall 2500 may be configured to pivot from the back of the containment unit 2000 to the front of the containment unit 2000. The pivoting wall 2500 itself may be made from steel and/or aluminum (or a combination of the two) and may be treated with a fire-resistant coating. When in a downward pivoted position (for example, in FIG. 16) an item, for example, an electric vehicle, can enter the containment area by being pushed into the containment unit 2000 or drawn into the containment unit 2000 by using the actuator 2800. When in an upward position (for example, in FIG. 20), the pivoting wall 2500 may be substantially vertical. When in the upwards portion the pivoting wall 2500 seals off the containment area and creates a substantially watertight containment area.

In the nonlimiting example of FIGS. 16-26 the containment unit 2000 may be transported by a vehicle from one location to another. For example, the containment unit 2000 may be transported to be near an electric vehicle which may or may not be smoldering or actively burning. In operation containment unit 2000 may be transported to the electric vehicle and unloaded from the vehicle. Once unloaded, the pivoting wall 2500 may be pivoted to its downward pivoted position (as shown in FIG. 16) and a cable from the actuator 2800 may be pulled through the containment area and to the electric vehicle and may be attached to the electric vehicle via a conventional means such as, but not limited to, a hook or a clamp. The actuator 2800 (for example a winch) may then be actuated to pull the electric vehicle across the pivoting wall 2500 and into the containment area. After the electric vehicle is in the containment area the pivoting wall 2500 may be pivoted to its upward position (as shown in FIG. 20).

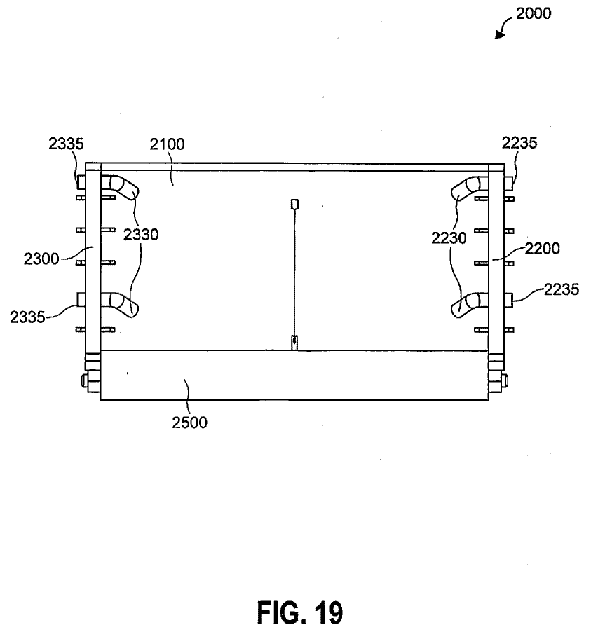

As previously explained, electric vehicles may be difficult to extinguish once they catch fire. The nearby physical environment, such as the ground or nearby structures or vehicles, is protected from a smoldering or burning electric vehicle by virtue of being in the containment area. However, in the nonlimiting example of FIGS. 16-26 containment unit 2000 includes additional features which may facilitate extinguishing any fire present in the containment unit 2000. For example, as shown in the various figures, the side walls 2200 and 2300 include ports 2230 and 2330 (see at least FIG. 19) through which water or other fire suppression material may enter the containment unit 2000. The ports 2230 and 2330 resemble pipes which, in some embodiments, maybe be arranged to have an angle of entry of about 30 degrees from the horizontal and/or vertical. It has been shown having an angle of entry of about 30 degrees expedites a cooling process as the water contacts an item in the containment area. Further, even if the water does not directly contact the item from the ports 2230 and 2330, angling the entry of water into the containment area creates a swirling effect in the containment area which facilitates cooling. In the nonlimiting example of FIGS. 16-26 the ports 2230 and 2330 are angled so as to be directed towards the front wall 2100, though the invention is not limited thereto. For example, the ports 2230 and 2330 may be directed towards the pivot all 500 which may also promote water circulation.

In one nonlimiting example embodiment of FIGS. 16-26 the ends 2235 and 2335 of the ports 2230 and 2330 may be configured to connect to conventional firehoses. Therefore, a conventional firetruck having water storage capacity may easily connect their water supply to the containment unit 2000 to deliver water to the containment area via the ends 2235 and 2335 to introduce water into the containment area to submerge a smoldering item to the level required, such as a smoldering electric vehicle. Associated with the ports 2230 and 2330 are valves which may be shut off to the ports 2230 and 2330 to prevent water from exiting the containment area via the ports 2230 and 2330. The valves allow safe firefighter operation as it allows for disconnecting or changing the water supply line without excess pressure and without losing any contaminated water. In the example embodiment of FIGS. 16-26 four ports are shown, however, the invention is not limited thereto as another version of the containment unit 1000 may have more than four ports or less than four ports.

As explained above, the containment unit 2000 may contain an item, for example, an electric vehicle, where the containment area is filled with water to the level required to suppress the fire. To remove the water from the containment unit 1000 the floor 2400 may be fitted with multiple water drains. For example, the floor 2400 may have one or more water drains. In one example, the floor 2400 includes one center floor drain arranged at the base of the pivoting wall 2500 and may be used as a “last drain used” to capture residual contaminated water not evacuated with primary evacuation valves (below). In one nonlimiting example embodiment, less than 5 gallons may remain to be removed via this drain. Another drain may be comprised of a primary evacuation valve and standard fire department connection in the very rear of each side down at floor level. In one embodiment, the containment unit 2000 includes one on each side, but the invention may, in actuality, have more than two evacuation valves. Hazmat services that may be needed to evacuate the water and properly treat/dispose the water typically use fire department standard hose and connections, so the containment unit 2000 is compatible for them. In the example embodiment of FIGS. 16-26, having ports 2230 and 2330 allowing entry of water via a hose and drains allowing for draining of the containment unit 2000 allows for active pumping via one or more hoses as well gravity drain via a hose to drain most of, if not all of, the contaminated water. This can be used for enhanced water circulation to expedite cooling by pulling hot/contaminated water out of the containment area and into an exterior tank of a hazmat truck while still pumping water in on the other end of the chamber, even during active fire. Locating evacuation valves at the rear of the containment area and intake valves at opposite end promotes flow and circulation.

In the example of FIGS. 16-26 the containment unit 2000 may be moved from one location to another under the influence of a truck. The containment unit 1000 may be disconnected from the vehicle so as to be a stand alone unit.

Though not shown in the figures, the nonlimiting example of FIGS. 16-26 may include additional features. For example, the containment unit 2000 of FIGS. 16-26 may additionally include heavy duty slots embedded in or attached to the bottom of the floor 2400 for forklift rails. This would allow a forklift to interface with and move the containment unit 2000. The slots may be configured to allow a forklift to interface with the containment unit 2000 from either side and allows for ease, speed, and safety when moving the containment unit 2000 around within a storage yard or facility. This also allows the containment unit 2000 to potentially be stacked with another containment unit 2000 which may reduce a storage footprint.

So far, two example embodiments of a containment unit 1000 and 2000 have been described. It is understood the described containment units 1000 and 2000 are for purpose of illustration only and are not meant to limit the invention. The following are some proposed specifications for the example containment units.

### Containment Unit 2000

Ports may be designed of brass
The frame of the box portions may be fabricated using steel, aluminum or another material, for example, carbon fiber. The sheets and or door/ramp may be made of steel, aluminum or another material, for example, carbon fire.
The drainage ports may be located below the vehicle floor to allow complete drainage.
Weight of containment unit may be about ˜5750 pounds or less
Box length with pivot wall up may be 24′
Overall length (including rails and winch cabinet with ramp up) may be about 25′9″
Overall length with ramp down (not including winch cabinet) may be about 27′5″
Overall length with ramp down (including winch cabinet): may be about 29′ 1.5″
Box width may be about 102″
Overall width (including ladders and accessories) may be about 105.75″
Overall height may be about 58′
Lower water fill height from ground may be about 24.5′
Upper water fill height from ground may be about 53.5′
Interior Vehicle Compartment Dimensions
   a) Length: may be about 25′6.25″
   b) Width: may be about 7′ 11.625″
   c) Height: may be about 47.8125″
   d) Max water height: may be about 43″
May accommodate all stock EVs sold today
May accommodate vehicles with length up to max of 280.6″ (49″ longer than F150 Lightning)
May accommodate vehicles with width up to max of 95.6″ (9″ wider than Hummer EV)
May accommodate vehicles with an approach and breakover angle larger than 11.5 degrees (accommodates all current EVs including Tesla Model 3 and Porshe Taycan)
May requires 3500 gallons to fill a container 30″ without Vehicle.

### Containment Unit 1000

Very similar to roll off box (2000) for all specs except weight and overall length
Tongue may add 4′-5′ to overall length, therefore ˜28′-29′
Weight may be about ˜7500 lbs
Maximum total weight<17,000 lbs, and <typical 20,000 lbs. max for safe towing by many types of pickup trucks
EV Hummer weight is 9,063 lbs. Total combined weight 16,600 lbs.
F150 Lightning EV weight is 6,015 lbs. Total combined weight is 13,500 lbs.
Heaviest Tesla is 5,390 lbs. (Model X Plaid) Total combined weight 12,900 lbs.
Fast-Drop support legs allow for addition of water weight (may be parked)

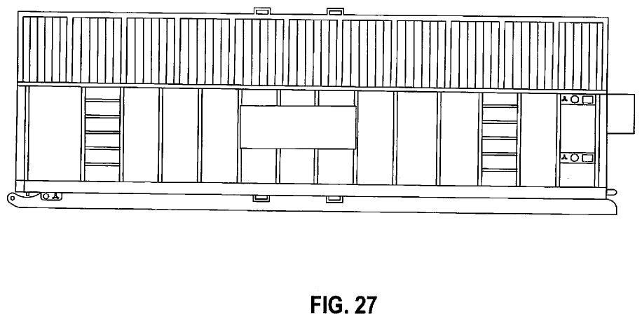

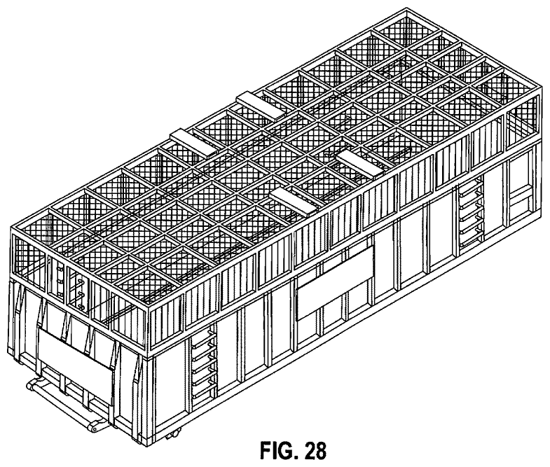

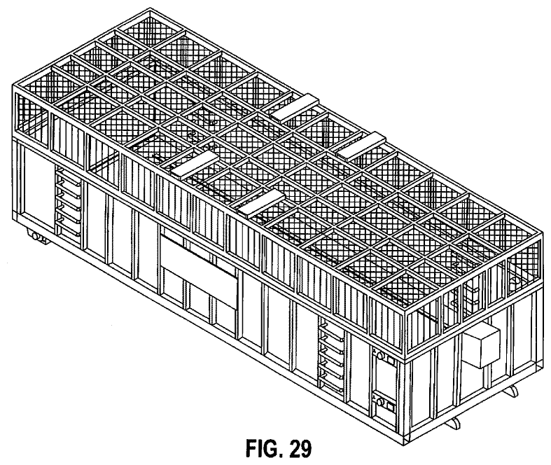

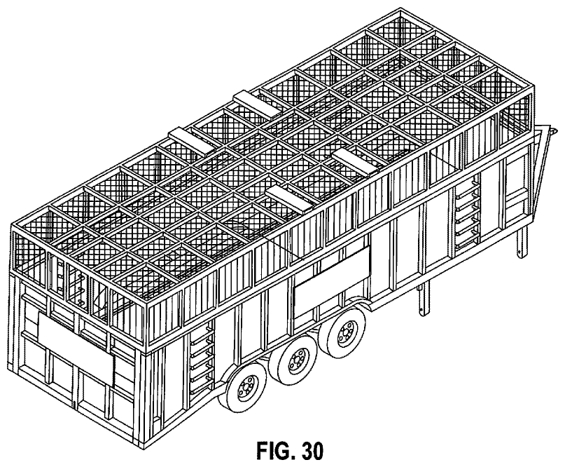

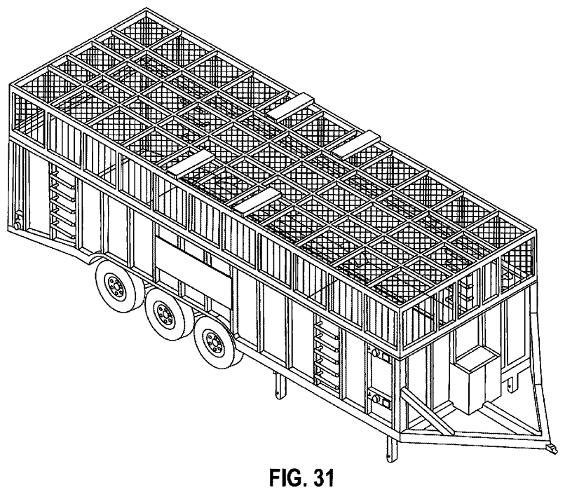

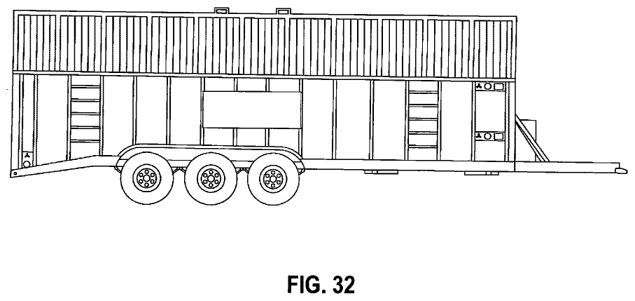

FIGS. 27 to 32 illustrate additional modifications of the containment units 1000 and 2000. For example, as shown in FIGS. 27-32, the containment units may include a cage mounted to their tops. The cage may serve several functions including functioning as an antitheft device.

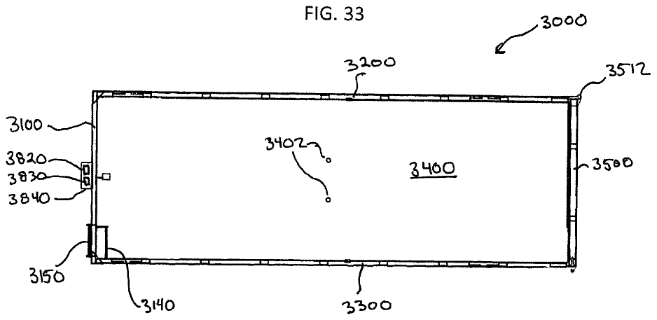

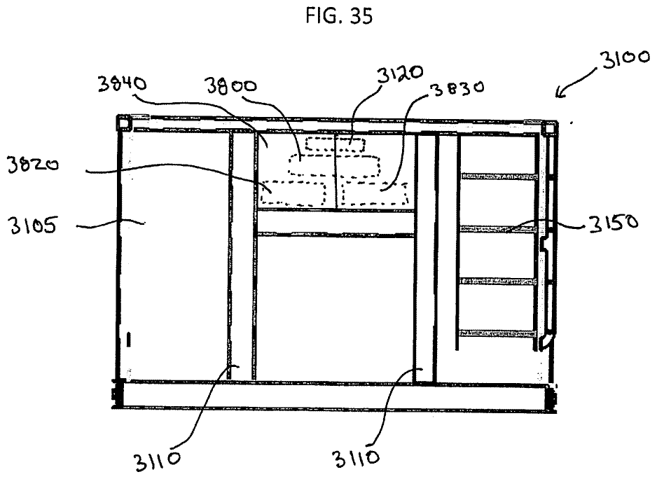

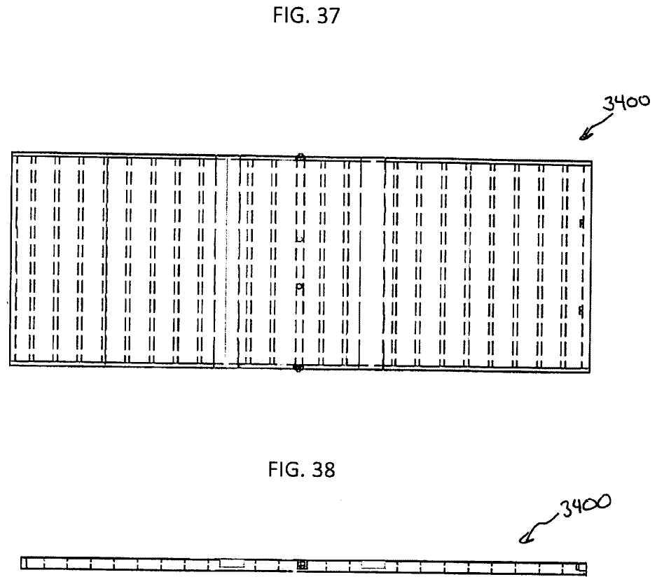

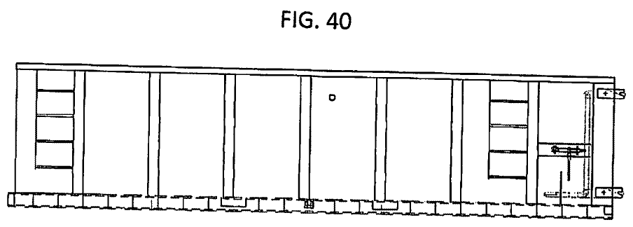

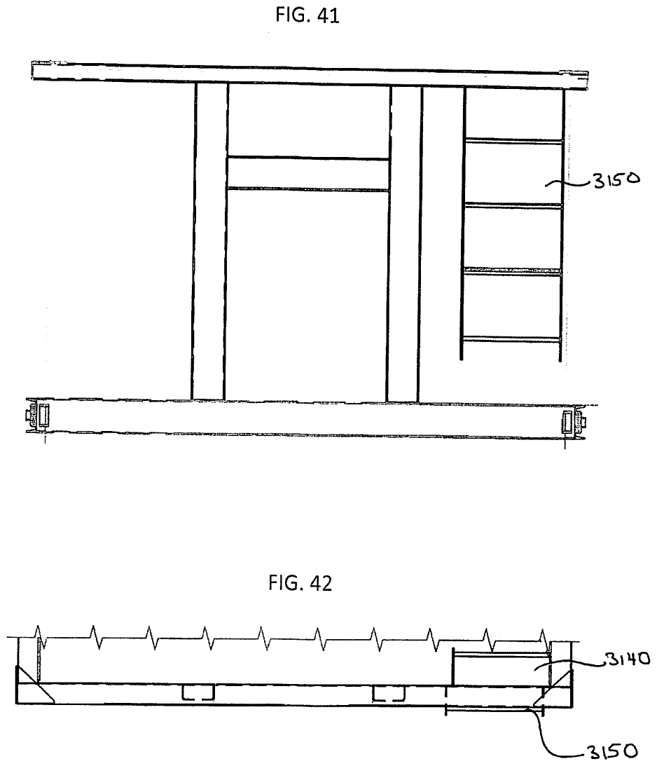

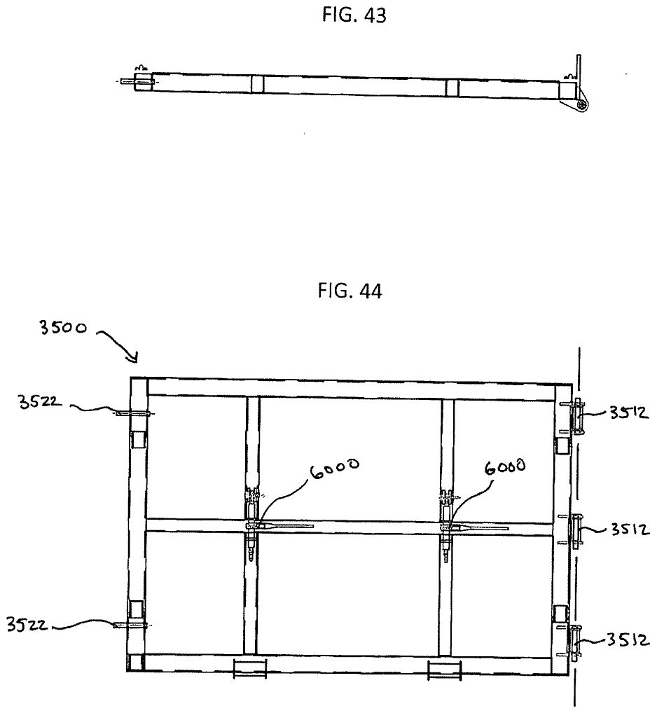

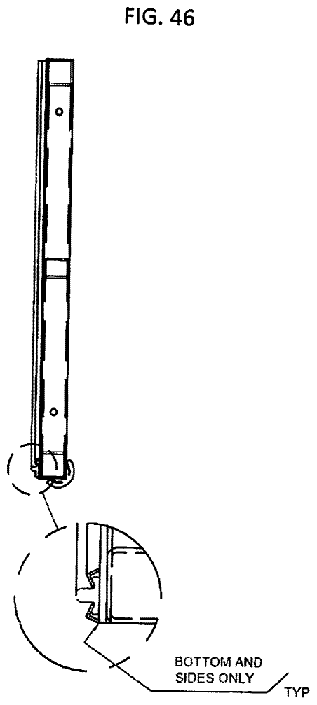

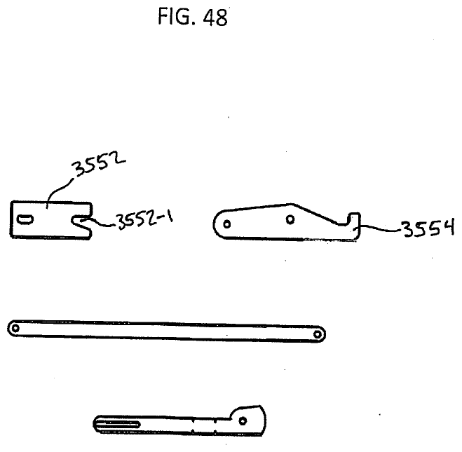

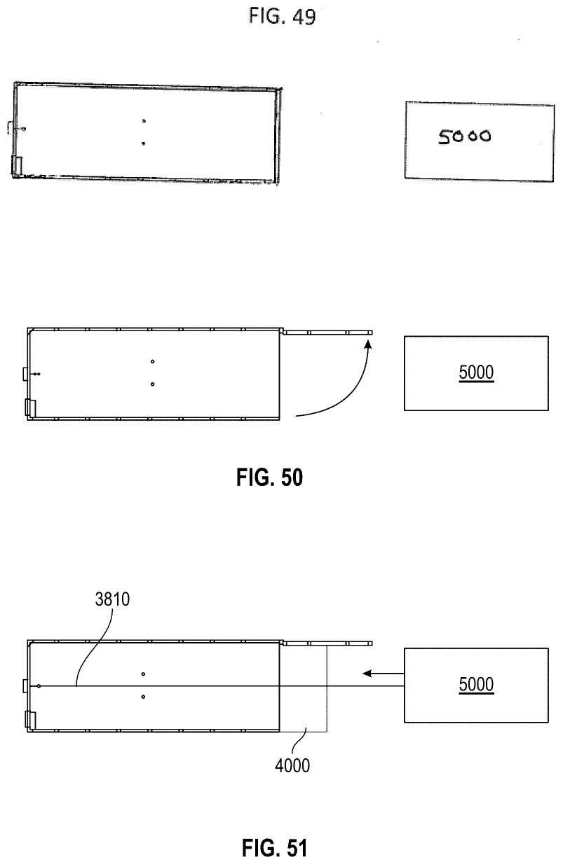

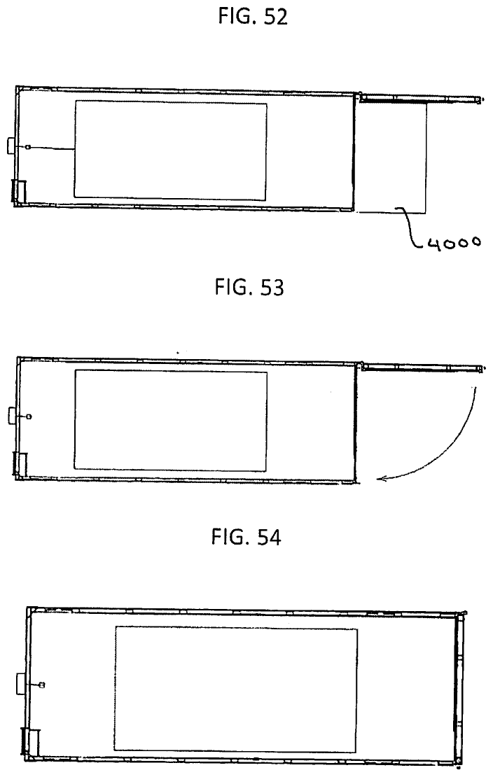

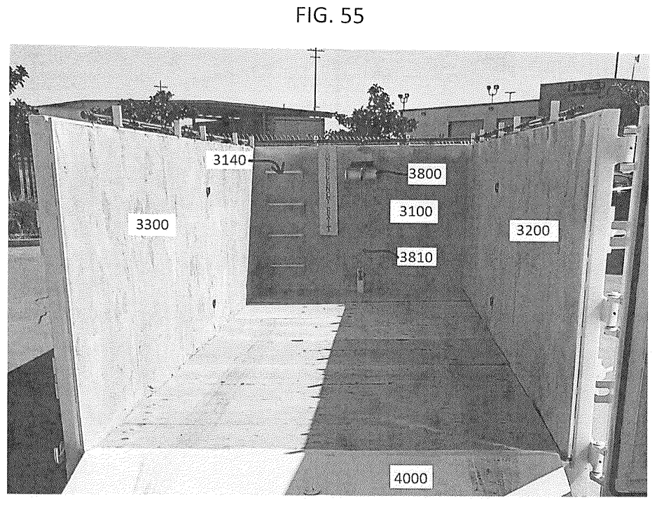

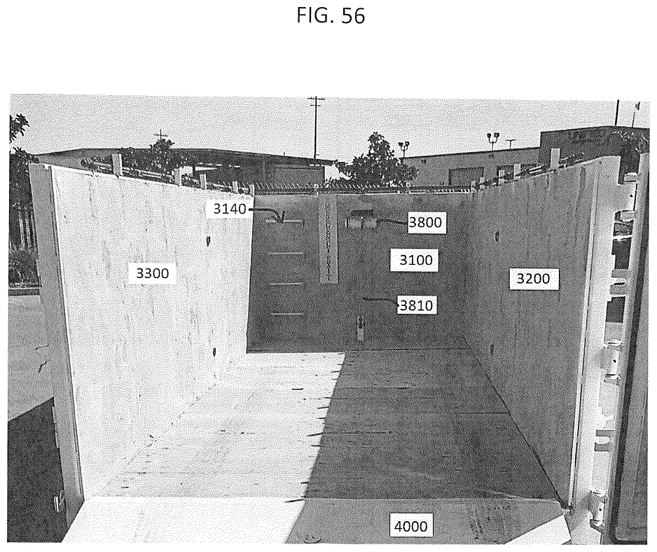

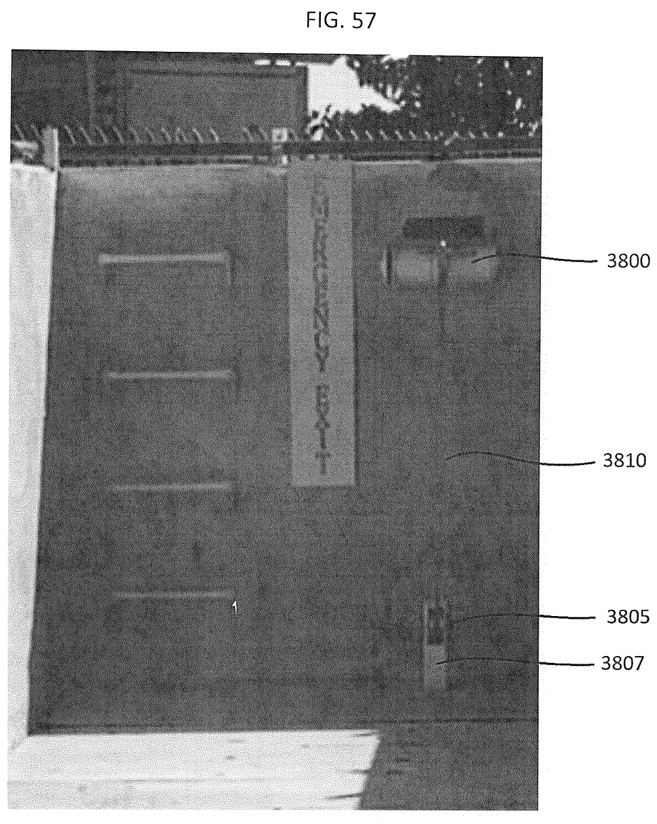

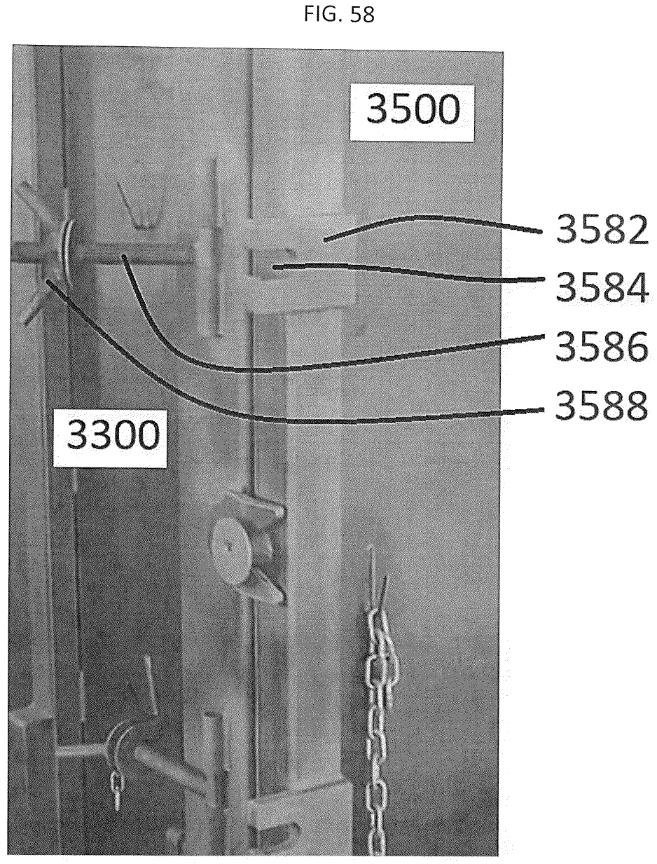

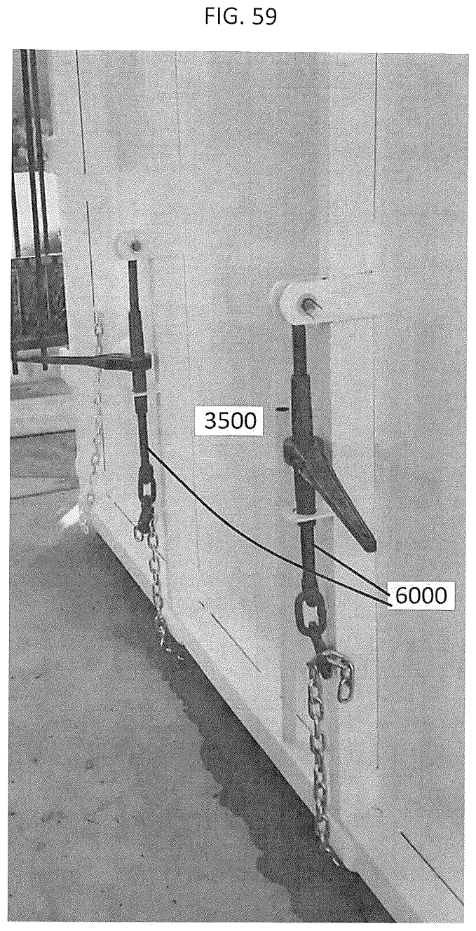

FIGS. 33-54 illustrate yet another example of a containment unit 3000 in accordance with example embodiments. As shown in FIGS. 33-54, the containment unit 3000 may be generally box shaped and sized to accommodate an item, such as, but not limited to, an electric vehicle. In the nonlimiting example of FIGS. 33-54 the containment unit 3000 has a front wall 3100, a first side wall 3200, a second side wall 3300, a floor 3400, and a pivoting wall 3500 (which unlike the previous embodiments, opens sideways). The front wall 3100, first side wall 3200, second side wall 3300, floor 3400, and pivoting wall 3500 may be thought of as forming a box. The pivoting wall 3500 may be pivoted sideways, as shown in at least FIGS. 49-50, to allow the item, for example, an electric vehicle, to enter the containment unit 3000. The pivoting wall 3500 may be pivoted sideways, as shown in at least FIGS. 53-54, to contain the item and prevent the item from exiting the containment unit 3000. In the nonlimiting example embodiment of FIGS. 33-54, the containment unit 3000 is configured as a mobile unit. As such, the containment unit 3000 may additionally include wheels 600 (like that shown in at least FIG. 1) to impart mobility to the containment unit 3000. However, as shown in FIGS. 33-54 the containment unit 3000 is shown as having rollers 3600 at one end to assist the containment unit in rolling, for example, on to a bed of a truck or trailer. The containment unit 1000 may further include a coupler 700, like that shown in FIG. 1, or the coupler 700 may be omitted as shown in the figures. The coupler 700, in one nonlimiting embodiment, may receive a trailer ball from a towing vehicle, however it is understood the invention is not limited thereto. Additionally, the containment unit 3000 may be configured without wheels or rollers and may simply lay flat on the ground.

In example embodiments the containment unit 3000 of FIGS. 33-54 may be used to transport an item susceptible to fire. For example, it is well known electric vehicles are prone to fire of such intensity that it is difficult to extinguish. Such vehicles may be pushed into the containment unit 3000 when the pivoting wall 3500 is swung open allowing entrance to the containment unit 3000. A ramp 4000 may be provided so the item can gain entrance into a space formed by front wall 3100, first side wall 3200, second side wall 3300. When the pivoting wall 3500 is in a closed position, for example, as shown in FIG. 33, the space defined by the front wall 3100, the first side wall 3200, the second side wall 3300, the floor 3400, and the pivoting wall 3500 shall be referred to as a containment area. While pushing an item into the containment unit 3000 is certainly possible, the example embodiment of FIGS. 33-54 is not limited thereto as the containment unit 3000 may include an actuator 3800 arranged on or near the front wall 3100 which may facilitate bringing the item into the containment area so the item need not be pushed into the containment area. The actuator 3800, in one embodiment, is a winch with a cable 3810 that may attach to the item and pull the item into the containment area. The actuator 3800 may be powered by one or more power sources 3820 and 3830 which, in one embodiment, may be batteries. Although two power sources are shown in the figures, it is clear the actuator 3800 may be powered by a single power source or more than two power sources.

In the nonlimiting example of FIGS. 33-54 the front wall 3100 is illustrated as a substantially vertical wall with sheet 3105 and vertical members 3110. The front wall 3100 may be made from steel and/or aluminum (or a combination of the two) and may be treated with a fire-resistant coating. The vertical members 3110 may be made from any suitable members such as, but not limited to, square or rectangular metallic and/or nonmetallic tubing, angled metal (for example, angle iron), metallic and/or nonmetallic I-beams, metallic and/or nonmetallic H-Beams, or metallic and/or nonmetallic W-Beams. A box 3840 may be attached to the front wall 3100. The box 3840 may support, enclose, and/or protect the actuator 3800 and power sources 3820 and 3830. In one nonlimiting embodiment, the box 3840 may include doors so a user can access the actuator 3800 and power sources 3820 and 3830. In the event the actuator 3800 includes the winch and cable 3810 the front wall 3100 may include a hole 3120 through which the cable 3810 may pass and enter the containment area. The hole 3120, in one nonlimiting example embodiment, may have a seal applied thereto to allow the cable to pass through the front wall 3100 while making the hole 3120 substantially water proof. In another embodiment the hole 3120 is arranged above an anticipated water level in the containment unit 3000 thus obviating the need for a seal. In yet another embodiment the cable 3810 is routed over the top of the front wall 3100. In the nonlimiting example of FIGS. 33-54 a pulley system may be used to route the cable 3810 from the winch 3800 and to an item to be pulled. The pulley system may be configured to route the cable 3810 through the hole 3120 in the front wall 3100 or over the top of the front wall 3100.

In the nonlimiting example of FIGS. 33-54 the first and second side walls 3200 and 3300 are illustrated as a substantially vertical walls with panels 3205 and 3305 and vertical members 3210 and 3310. The first and second side walls 3200 and 3300 themselves may be made from steel and/or aluminum (or a combination of the two) and may be treated with a fire-resistant coating. The reinforcing members 3210 and 3310 may be made from any suitable members such as, but not limited to, square or rectangular metallic and/or nonmetallic tubing, angled metal (for example, angle iron), metallic and/or nonmetallic I-beams, metallic and/or nonmetallic H-beams, or metallic and/or nonmetallic W-beams. As shown in the figures, the first and second side walls 3200 and 3300 may each include one or more ladders 3220 and 3320 to allow a user to climb us the first and second side walls 3200 and 3300 to view the containment area. In the example of FIGS. 33-54 four ladders are provided (two on the outsides of the first and second side walls 3200 and 3300). This allows speed of access to monitor the containment area by standing on exterior ladders, and provides firefighters and/or technicians four places to view the containment area. Without the ladders a firefighter or technician may have difficulty view the containment area.

In the nonlimiting example of FIGS. 33-54 floor 3400 may be a substantially horizontal floor upon which the item, for example, an EV vehicle, may be placed. The floor 3400 itself may be made from steel and/or aluminum (or a combination of the two) and may be treated with a fire-resistant coating. The floor 3400 may be substantially horizontal but may also include areas which are inclined from the horizontal. The floor 3400 may also include guides which may help control the item as it is being drawn or pushed into the containment area. The guides may resemble angle iron or channel iron fixed to the floor 3400.

In the nonlimiting example of FIGS. 33-54 the pivoting wall 3500 may have an end 3505 configured to pivot about a vertical axis 3507. The pivoting wall 3500 itself may be made from steel and/or aluminum (or a combination of the two) and may be treated with a fire-resistant coating. When the pivoting door 3500 is pivoted to an open position, for example, as shown in FIG. 50, an item, for example, an electric vehicle, can enter the containment area by being pushed into the containment unit 3000 or drawn into the containment unit 3000 by using the actuator 3800. When in a closed position, for example, as shown in FIG. 54, the pivoting wall 3500 seals off the containment area and creates a substantially watertight containment area.

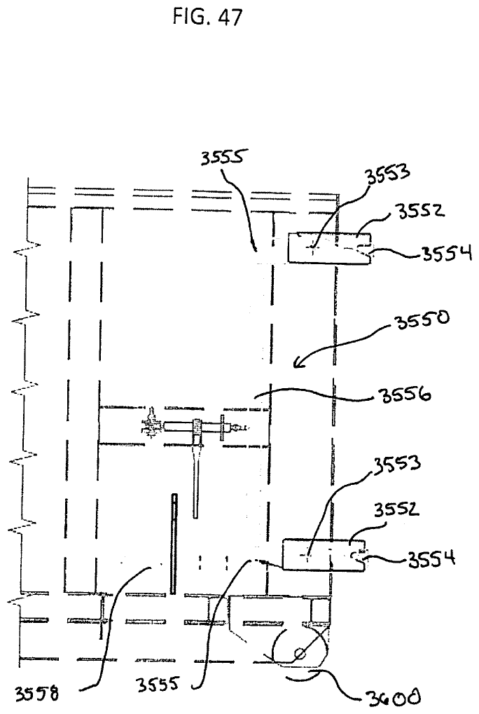

In the nonlimiting example of FIGS. 33-54 the pivoting wall 3500 is shown having a first side 3510 and a second side 3520. The first side 3510 may be pivotally connected with respect to the first wall 3200. For example, the first side 3510 of the pivoting wall 3500 may have hinges 3512 which hingedly connect the first side 3510 of the wall 3500 to the first wall 3200. The second side 3520 of the pivoting wall 3500 may include projections 3522 (which may resemble latch pins) receivable by a latching mechanism 3550 which may latch the pivoting wall 3500 to the second side wall 3300. For example, as shown in FIG. 47, the latching mechanism 3550 may include a pair of latch receivers 3552 attached to the second side wall 3300. The latch receivers 3552 may resemble flat plates having notches 3552-1 to receive the projections 3552 as the pivoting wall 3500 closes. The projections 3522 may be trapped in the notches 3552-1 by latch hooks 3554 which may be pivotally connected to the latch receivers 3552 at pivot points 3553. The latch hooks 3554 may be pivotally connected to the latch receivers 3552 at pivot points 3553. For example, bolts may be used to provide the pivotal connections at the pivot points 3553. To actuate (or rotate) the latch hooks 3554 a latch pivot arm 3556 may be provided which is pivotally connected to each of the latch hooks 3554 at pivot points 3555. For example, the pivot points 3555 may be provided using a bolt to attach ends of the pivot arm 3556 to the latch hooks 3554. A latch handle 3558 may be rigidly attached to the bottom latch hook 3554 so that as the latch handle 3558 is raised the latch hooks 3554 pivot clockwise to expose the notches 3552-1 of the latch receivers 3552. Thus, in operation, to secure the pivoting wall 3500 in place the pivoting wall 3500 may be rotated until the projections 3522 are received in the notches 3552-1 of the latch receivers 3552. Thereafter, the latch handle 3558 may be pushed downwards to rotate the latch hooks 3553 counterclockwise until they are in the position illustrated in FIG. 47 in which case the pivoting wall 3500 is latched in a closed position.

In the nonlimiting example of FIGS. 33-54 the containment unit 3000 may be towed by a vehicle from one location to another. For example, the containment unit 3000 may be towed near an electric vehicle 5000 which may or may not be smoldering. In operation the pivoting wall 3500 may be pivoted to an open position (as shown in FIG. 50) and a cable 3810 from the actuator 3800 may be pulled through the containment area and to the electric vehicle 5000 and may be attached to the electric vehicle via a conventional means such as, but not limited to, a hook or a clamp (see FIGS. 50 and 51). The actuator 3800 (for example a winch) may then be actuated to pull the electric vehicle 5000 across the ramp 4000 and into the containment area. After the electric vehicle 5000 is in the containment area the pivoting wall 500 may be pivoted shut (as shown in FIGS. 53-54) and the pivoting wall 500 may be secured in place via the latching mechanism 3550.

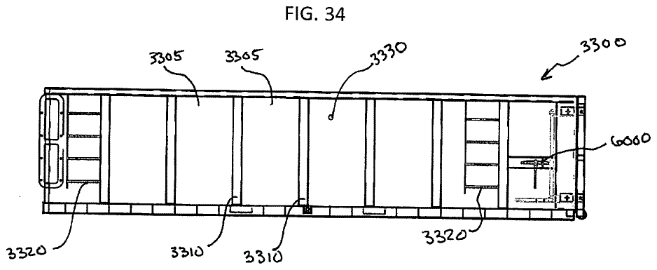

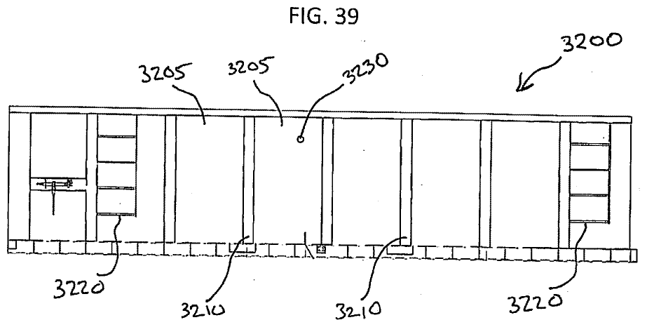

As previously explained, electric vehicles may be difficult to extinguish once they catch fire or re-ignite. The nearby physical environment, such as the ground or nearby structures or vehicles, is protected from a smoldering or burning electric vehicle by virtue of being in the containment area. However, in the nonlimiting example of FIGS. 33-54 containment unit 3000 includes additional features which may facilitate extinguishing any fire present in the containment unit 3000. For example, as shown in the various figures, the side walls 3200 and 3300 include ports 3230 and 3330 (see at least FIGS. 34 and 39) through which water or other fire suppression material may enter the containment unit 3000 to drown a smoldering EV.

In one nonlimiting example embodiment of FIGS. 33-54 the ports 3230 and 3330 may be configured to connect to conventional fire hoses. Therefore, a conventional firetruck having water storage capacity may easily connect their water supply to the containment unit 3000 to deliver water to the containment area via the ports 3230 and 3330 to introduce water into the containment area to submerge a smoldering item, such as a smoldering electric vehicle. In some embodiments the ports 3230 and 3330 may include valves which may shut off the ports 3230 and 3330 to prevent water from exiting the containment area via the ports 3230 and 3330. The valves allow safe firefighter operation as it allows for disconnecting or changing the water supply line without excess pressure and without losing any contaminated water. In the example embodiment of FIGS. 33-54 two ports are shown, however, the invention is not limited thereto as another version of the containment unit 3000 may have more than two ports or less than two ports.

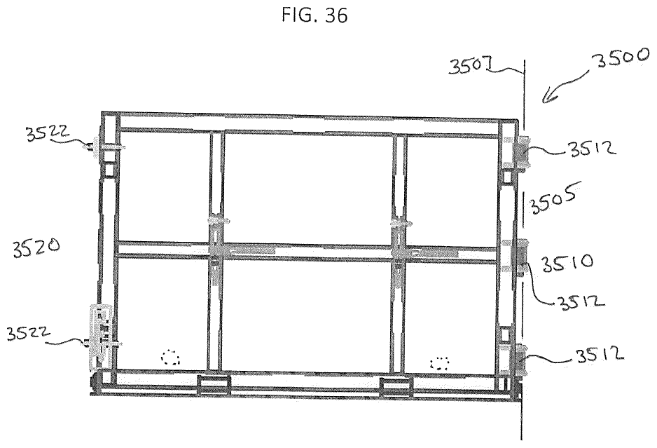

As explained above, the containment unit 3000 may contain an item, for example, an electric vehicle, where the containment area is filled with water to a level required to extinguish a fire. To remove the water from the containment unit 3000 the floor 3400 may be fitted with one or more water drains. In one example, the floor 3400 includes a pair of center floor drains 3402 arranged in the middle of the floor 3400. In another embodiment, the floor drains may be placed near the bottom of the pivoting wall 3500 as shown in FIG. 36 as dashed lines. Hazmat services that may be needed to evacuate the water and properly treat/dispose the water typically use fire department standard hose and connections, so the containment unit 3000 is compatible for them. In the example embodiment of FIGS. 1-15, having ports 3230 and 3330 allowing entry of water via a hose and drains allowing for draining of the containment unit 3000 allows for active pumping via one or more hoses as well gravity drain via a hose to drain most of, if not all of, the contaminated water. This can be used for enhanced water circulation to expedite cooling by pulling hot/contaminated water out of the containment area and into an exterior containment vessel or tank of a hazmat truck while still pumping water in on the other end of the chamber, even during active fire. Locating evacuation valves at the rear of the containment area promotes flow and circulation.

In the example of FIGS. 33-54 the containment unit 3000 may be moved from one location to another under the influence of a vehicle, such as, but not limited to, a car or a truck. The containment unit 3000 may be disconnected from the vehicle so as to be a stand alone unit. For example, the containment unit 3000 may be rolled on and off a roll off truck using rollers 3600 that may be present on the containment unit 3000.

Though not shown in the figures, the nonlimiting example of FIGS. 33-54 may include additional features. For example, the containment unit 3000 of FIGS. 33-54 may additionally include heavy duty slots attached to or embedded in the bottom of the floor 3400 for forklift rails. This would allow a forklift to interface with and move the containment unit 3000. The slots may be configured to allow a forklift to interface with the containment unit 3000 from either side and allows for ease, speed, and safety when moving the containment unit 3000 around within a storage yard or facility. This also allows the containment unit 3000 to potentially be stacked with another containment unit 1000 which may reduce a storage footprint.

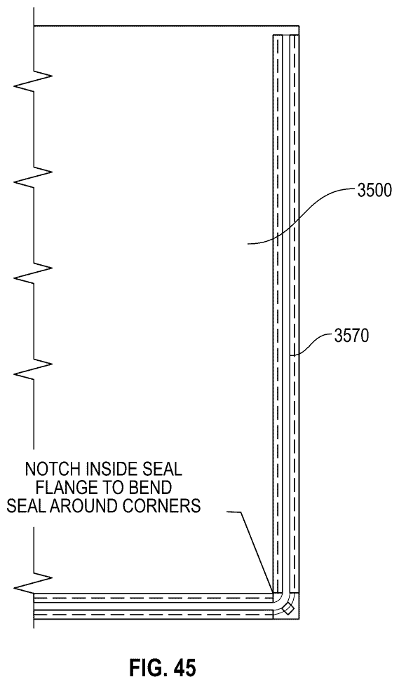

As yet another example, the front wall 3100 may include a first ladder 3140 allowing facing an inside of the containment area and a second ladder 3150 on the outside of the front wall 3100. The first and second ladders 3140 and 3150 allow a person to enter and leave the container 3000 by climbing over the front wall 3100. As yet another example, seals 3570 may be placed along the bottom and edges of the pivoting wall 3500 as shown in at least FIG. 45 to prevent water or some other fire suppressant material from leaking around the edges of the pivoting wall 3500. As yet another example, chain boxes 6000 may be installed with chains to facilitate and tighten the seals 3570. The chain boxes 6000 resemble a ratcheting type mechanism having a chain that connects to a bottom of the container 3000 and can be ratcheted to tighten the seals (see FIG. XXX). As yet another example, additional clamps 3580 may be provided to further clamp the pivoting wall 3500 to the first and second sidewalls 3200 and 3300. For example, the clamps may include a plate 3582 with a notch 3584 into which a threaded shaft 3586 may be rotated into and secured in place with by turning a handle 3588 which may be threadingly engaged with the shaft 3586.

What is claimed is:

1. A method of moving an electric vehicle comprising:
providing a containment unit adjacent the electric vehicle, the containment unit comprising a front wall, a first side wall, a second side wall, and a pivoting wall;
pivoting the pivoting wall to expose an inside of the containment unit;
attaching a cable to the electric vehicle;
operating a winch to draw the electric vehicle between the first side wall and the second side wall;
pivoting the pivoting wall to create a water tight containment unit.

2. The method of claim 1, wherein the containment unit further includes a seal between the pivoting wall and the first side wall second side wall.

3. The method of claim 1, wherein the containment unit further includes a first ladder on a first side of the front wall and a second ladder on a second side of the front wall.

4. The method of claim 1, wherein the front wall includes an aperture through which a cable of the winch passes.

5. The method of claim 1, wherein the front wall, the first side wall, the second side wall, and the pivoting wall have a fire resistant material applied to their inner surfaces.

6. The method of claim 1, wherein the pivoting wall includes at least one port to allow water to exit the containment unit.

7. The method of claim 1, wherein a first port extends through the first side wall and a second port extends through the second side wall.

8. The method of claim 1, wherein the containment unit further includes a box on the front wall supporting at least one power source to power the winch.

9. The method of claim 1, wherein the pivoting wall pivots about a horizontal axis.

10. The method of claim 1, wherein the containment unit further includes a latching mechanism configured to latch the pivoting wall closed.

11. A method of moving an electric vehicle comprising:
providing a containment unit having a front wall, a first side wall having at least one port configured to facilitate water flowing into the containment unit, a second side wall having at least one port configured to facilitate water flowing into the containment unit, a winch configured to move an electric vehicle between the first and second sidewalls, and a pivoting wall opposite the front wall, wherein when the pivoting wall is in a closed position the front wall, first side wall, the second side wall and the pivoting wall form a watertight container;
rotating the pivoting wall;
activating the winch to draw the electric vehicle over the pivoting wall and into the containment unit.

12. The method of claim 11, wherein the winch is supported by the front wall.

13. The method of claim 11, wherein the containment unit includes a seal between the pivoting wall and the first side wall second side wall.

14. The method of claim 13, wherein the seal is between the pivoting wall and ends of the first side wall and second side wall.

15. The method of claim 11, wherein the pivoting wall pivots about a horizontal axis.

16. The method of claim 11, wherein the horizontal axis is arranged near a bottom of the pivoting wall.
